(19) United States
(12) Patent Application Publication
(10) Pub. No.: US 2009/0052917 A1
(43) Pub. Date: Feb. 26, 2009

(54) Image forming apparatus

(76) Inventors: Seiichi Kogure, Kanagawa (JP); Shinji Imoto, Tokyo (JP)

Correspondence Address: COOPER & DUNHAM, LLP, 30 Rockefeller Plaza, 20th Floor, NEW YORK, NY, 10112, US

(21) Appl. No.: 11/662,616

(22) PCT Filed: Jul. 18, 2006
(86) PCT No.: PCT/JP2006/314533

§ 371 Date: Mar. 12, 2007

(30) Foreign Application Priority Data
Jul. 19, 2005 (JP) 2005-207913

(51) Int. Cl. G03G 15/10

(52) U.S. Cl. 399/55; 399/240

(57) ABSTRACT

A disclosed image forming apparatus comprises: a conveying belt conveying a record medium attracted to the conveying belt using electrostatic force; a recording head for ejecting droplets on the record medium and forming an image; and a voltage waveform applying unit applying voltage waveforms, in which the shape of a positive waveform and the shape of a negative waveform are different, to the conveying belt so as to apply positive and negative electric charge thereto and generate the electrostatic force.

### TECHNICAL FIELD

The present invention relates to an image forming apparatus, and more particularly to an image forming apparatus with a conveying belt for conveying a record medium.

### BACKGROUND ART

Ink-jet printing apparatuses are widely known as image forming apparatuses such as printers, facsimiles, copying machines, and the like. Recording (character printing, image printing, printing, image forming, and the like are used as having the same definition) is performed on a record medium such as recording paper (hereafter referred to as “paper” without being limited to paper material but including what is called a recording medium, transfer material, recording paper, and the like) by ejecting droplets of recording liquid such as ink drops thereon from a recording head, for example.

In such an image forming apparatus, it is necessary to increase the accuracy of impact positions of ink drops on paper so as to improve image quality. There are known methods in which an entire portion of a conveying belt for conveying paper is positively electrified, the paper is attracted to the conveying belt by attraction from electrostatic force, a constant distance is maintained between a recording head and the paper, displacement of paper is prevented by correctly controlling paper feeding, and flotation of paper is prevented, thereby preventing jams or dirt resulting from a collision between the paper and the recording head.

Patent Document 1: Japanese Laid-Open Patent Application No. 4-201469

Patent Document 2: Japanese Laid-Open Patent Application No. 9-254460

When the entire portion of the conveying belt for conveying paper is positively electrified so as to attract the paper to the conveying belt by attraction from electrostatic force and the paper is conveyed, droplets ejected from the recording head are displaced in image forming positions since the droplets are affected by a generated electric field and flight directions thereof are bent, for example. In addition, mist from the ejected droplets flows back and is attached to the vicinity of an ejection unit of the recording head, so that the quality of a formed image is decreased.

In view of this, as disclosed in Patent Document 3, there is a known method in which electric potential on a surface of a record medium is reduced and the ejected droplets are not affected from the electric field by applying electric charge having a polarity opposite to that of electric charge of the uniformly electrified conveying belt to the surface of the record medium conveyed to an image forming area of the recording head. Also, the paper is more tightly attracted to the conveying belt through attraction by reducing electric potential having the same polarity as that of the conveying belt from the surface of the paper.

Patent Document 3: Japanese Patent No. 3224528

In addition, as disclosed in Patent Document 4, there is a known electrifying method for the conveying belt, in which attraction is generated between the record medium and the conveying belt by applying an alternating electric charge having positive and negative polarities to the conveying belt.

Patent Document 4: Japanese Laid-Open Patent Application No. 2003-103857

As mentioned above, in the image forming apparatus where the record medium is attracted to the conveying belt by electrostatic force, an electric field is generated between the surface of the record medium and the recording head, so that ink drops ejected from the recording head are affected by the electric field and polarized. In accordance with this, the image forming apparatus is problematic in that flight of the drops is disturbed and recording cannot be performed in a good condition or ink mist generated from the flight of the drops flows back and is attracted to the vicinity of the ejection unit of the recording head as a result of polarization.

There has been an effective method for handling this problem as in an image forming apparatus disclosed in Patent Document 4, in which attraction is generated between the record medium and the conveying belt by applying an alternating electric charge having positive and negative polarities to the conveying belt. By carrying the induced electric charge with positive and negative polarities on the surface of the record medium at the same time, the electric charge with positive and negative polarities is offset and the surface electric potential on the record medium is reduced, so that the electric field that may cause displacement of impact positions of ink drops or a backflow of ink mist is reduced.

However, in such an image forming apparatus, it is necessary to control the amount of electric charge applied to the record medium in accordance with surface potential in order to correctly counteract the surface potential of the record medium under the recording head varying on the basis of the types of record media or the surface potential of the record medium varying on the basis of environment.

When such a control is performed, if balance between positive electric charge and negative electric charge applied to the conveying belt is not provided, difference is generated between the amount of positive electric charge and the amount of negative electric charge applied to the conveying belt. Thus, the electric charge induced on the record medium tends to be either positive or negative with the passage of time after being neutralized in the adjacent electric charge with positive and negative polarities.

In other words, regardless of the passage of time, the level of the electric charge on the record medium does not become a predetermined value or less, and it is not possible to control the displacement of impact positions resulting from the electric field under the recording head or dirt on the head resulting from the backflow of ink to a head surface.

### DISCLOSURE OF INVENTION

It is a general object of the present invention to provide an improved and useful an image forming apparatus in which the above-mentioned problems are eliminated.

A more specific object of the present invention is to provide an image forming apparatus that can have the same amount of electric charge for positive and negative polarities on a record medium using a simple construction, prevent the displacement of impact positions and the backflow of mist, and stably form a high-quality image.

In order to achieve the above-mentioned objects, an image forming apparatus according to the present invention includes a unit applying voltage waveforms having different positive and negative waveforms to the conveying belt.

In this case, preferably, a voltage waveform is applied such that application amount of positive and negative electric charge is substantially the same so as to have an absolute value of electric charge on a surface of the record medium not more than a predetermined value after a predetermined time has elapsed since the record medium is brought into contact with the conveying belt. In this case, preferably, the absolute value of electric charge on the surface of the record medium is not more than 0.3 kV after the predetermined time has elapsed. Further, a difference of balance between positive electric charge and negative electric charge applied to the conveying belt is not more than 5%.

The image forming apparatus according to the present invention includes a unit adjusting amount of positive and negative electric charge applied to the conveying belt so as to have an absolute value of electric charge on the surface of the record medium not more than a predetermined value after a predetermined time has elapsed since the record medium is brought into contact with the conveying belt.

In this case, preferably, the adjustment of amount of positive and negative electric charge applied to the conveying belt is performed by adjusting an alternating voltage for positive and negative electric charge applied to the conveying belt. Preferably, the adjustment of amount of positive and negative electric charge applied to the conveying belt is performed by adjusting a length of a rise time or a length of a fall time of an alternating voltage for positive and negative electric charge applied to the conveying belt. Or, preferably, the adjustment of amount of positive and negative electric charge applied to the conveying belt is performed by adjusting time of rising or falling of an alternating voltage for positive and negative electric charge applied to the conveying belt.

In the image forming apparatus, preferably, when positive and negative electric charge is applied to the conveying belt, electric charge having a polarity opposite to that of electric charge of frictional electrification is applied, application amount of the electric charge having the opposite polarity being greater than that of the electric charge of the frictional electrification generated by a rotation of the conveying belt. Preferably, application amount of the electric charge is adjusted in accordance with widths of positive and negative electric charge applied to the conveying belt. Further, preferably, application amount of the electric charge is adjusted in accordance with environmental humidity.

The image forming apparatus according to the present invention includes the unit applying voltage waveforms having different positive and negative waveforms to the conveying belt. Thus, it is possible to have an absolute value of electric charge on the surface of the record medium not more than a predetermined value after a predetermined time has elapsed since the record medium is brought into contact with the conveying belt. Also, it is possible to have a balance between positive charge and negative charge, to have the same amount of positive and negative electric charge on the record medium, and to prevent displacement of impact positions and backflow of mist by a simple structure, thereby stably forming a high-quality image.

The image forming apparatus according to the present invention includes a unit adjusting amount of positive and negative electric charge applied to the conveying belt so as to have an absolute value of electric charge on a surface of the record medium not more than a predetermined value after a predetermined time has elapsed since the record medium is brought into contact with the conveying belt. Thus, it is possible to have the same amount of positive and negative electric charge on the record medium and to prevent displacement of impact positions and backflow of mist by a simple structure, thereby stably forming a high-quality image.

Other objects, features and advantage of the present invention will become more apparent from the following detailed description when read in conjunction with the accompanying drawings.

### BRIEF DESCRIPTION OF DRAWINGS

FIG. 1 is a side elevational view showing an entire structure of a mechanical unit of an image forming apparatus according to an embodiment of the present invention;

FIG. 2 is a plan view showing main elements of the same apparatus;

FIG. 3 is an illustration showing an example of a conveying belt of the same apparatus;

FIG. 4 is an illustration showing another example of a conveying belt of the same apparatus;

FIG. 5 is a block diagram showing an outline of a control unit of the same apparatus;

FIG. 6 is an illustration showing units for controlling electrification in the same apparatus;

FIG. 7 is an illustration showing when a conveying belt is electrified;

FIG. 8 is an illustration showing when paper is brought into contact with the conveying belt;

FIG. 9 is an illustration showing an example of a measurement result regarding a relationship between surface potential and surface resistivity;

FIG. 10 is an illustration showing an example of a measurement result regarding a relationship between electrification cycle length and surface potential in record media having different surface resistivity;

FIG. 11 is an illustration showing an example of a measurement result regarding a relationship between electrification cycle length and attraction in record media having different surface resistivity;

FIG. 12 is an illustration showing a voltage waveform regarding a relationship between voltage application using different positive and negative voltage values and surface potential on paper;

FIG. 13 is an illustration showing surface potential on paper;

FIG. 14 is an illustration showing a voltage waveform regarding a relationship between voltage application using the same positive and negative voltage values and surface potential on paper;

FIG. 15 is an illustration showing surface potential on paper;

FIG. 16 is an illustration showing an example of an evaluation result of surface potential on paper, an image, and nozzle dirt;

FIG. 17 is an illustration showing an example of an evaluation result of a balance between application amount of positive and negative charge, an image, and nozzle dirt;

FIG. 18 is a block diagram showing main elements for applying electric charge according to other embodiment of the present invention;

FIG. 19 is an illustration showing rise time and fall time of positive and negative voltage application;

FIG. 20 is an illustration showing rise time and fall time of positive and negative voltage application, where lengths of the rise time and fall time are the same and application amount of positive and negative charge is different;

FIG. 21 is an illustration showing an example of different lengths of rise time and fall time of positive and negative voltage application for having the same application amount of positive and negative charge;

FIG. 22 is an illustration showing time for outputting positive and negative voltage application;

FIG. 23 is an illustration showing the same input time for positive and negative voltage application and different application amount of positive and negative charge;

FIG. 24 is an illustration showing an example of different input time for positive and negative voltage application for having the same application amount of positive and negative charge;

FIG. 25 is an illustration showing materials and readiness of frictional electrification; and

FIG. 26 is an illustration showing surface potential on paper and backflow of mist.

### BEST MODE FOR CARRYING OUT THE INVENTION

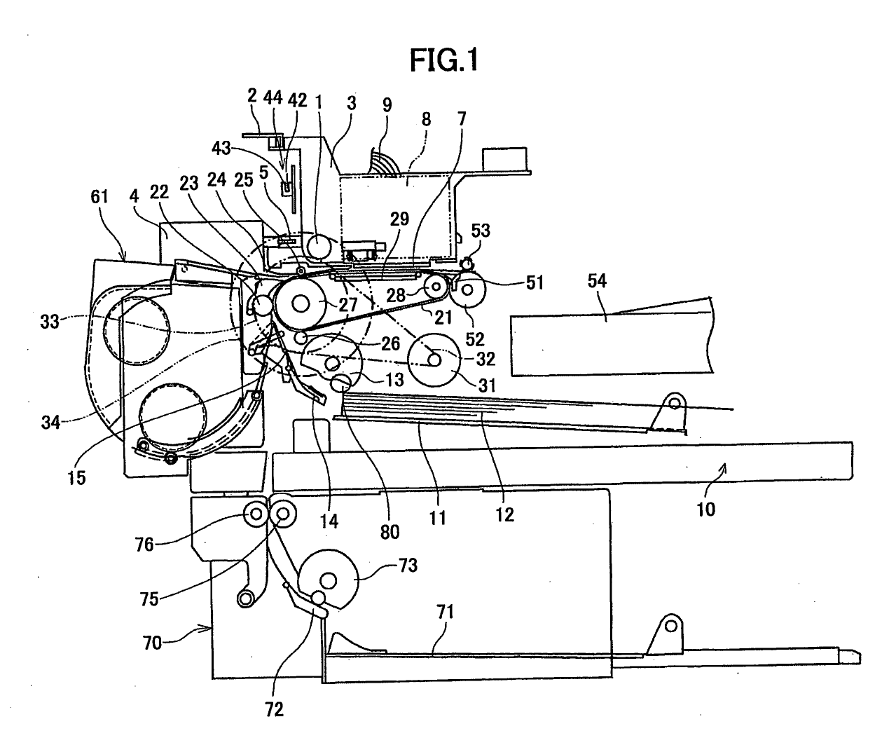

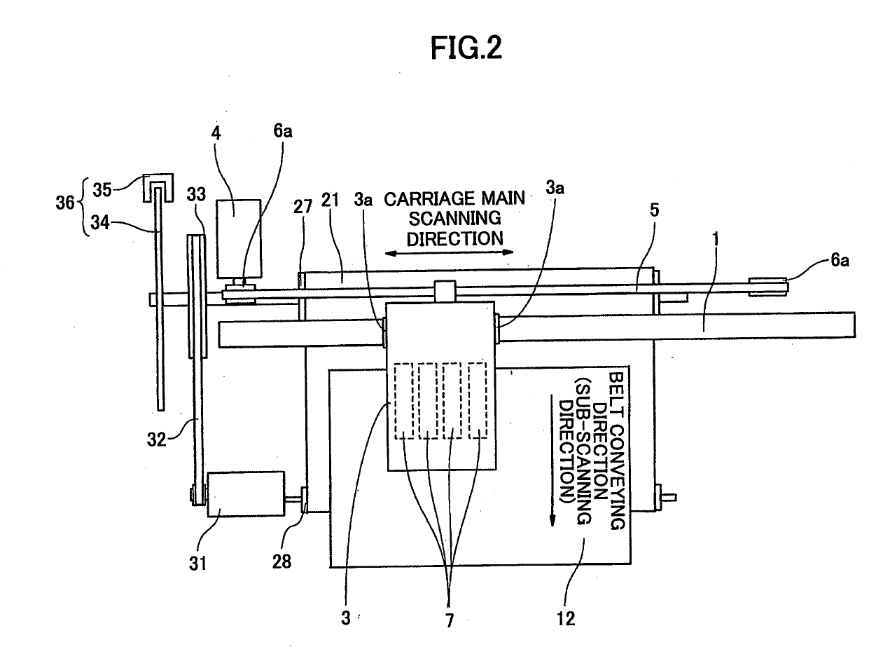

In the following, embodiments of the present invention will be described with reference to the accompanying drawings. First, a first embodiment of an image forming apparatus according to the present invention is described with reference to FIGS. 1 and 2. FIG. 1 is a side elevational view showing an entire structure of a device unit of the image forming apparatus and FIG. 2 is a plan view showing main elements of the same apparatus.

The image forming apparatus holds a carriage 3 slidably in a main scanning direction with a guide rod 1 and a guide rail 2 as guide members laterally placed on right and left side plates not shown in the drawings. A main scanning motor 4 moves the carriage 3 via a timing belt 5 installed between a driving pulley 6a and a driven pulley 6b so as to scan in a direction indicated by an arrow (main scanning direction) in FIG. 2. In addition, guide bushes (bearings) 3a and 3a are disposed between the carriage 3 and the guide rod 1.

In the carriage 3, four recording heads 7 made of droplet ejection heads each ejecting yellow (Y), cyan (C), magenta (M), and black (B) ink drops are arranged such that a direction of plural ink ejection outlets crosses the main scanning direction, and the four recording heads are mounted such that an ejection direction of ink drops is directed downward.

Examples of the droplet ejection heads constituting the recording heads 7 include a piezoelectric actuator such as a piezoelectric element, a thermal actuator using film boiling of liquid with an electrothermal conversion element such as a heat element, a shape memory alloy actuator using metallic shape change by temperature change, an electrostatic actuator using electrostatic force as an energy generating unit ejecting an ink (recording liquid). In addition, the recording heads may be constructed using a single or plural droplet ejection heads provided with plural nozzles for ejecting different colors.

In the carriage 3, sub-tanks 8 of each color for supplying ink of each color to the recording heads 7 are mounted. Ink is supplied to the sub-tanks 8 from a main tank (ink cartridge) not shown in the drawings via an ink supplying tube 9. Other than the recording heads 7 for ejecting ink drops, it is possible to mount a recording head for ejecting a process liquid for fixing (fixing ink) for enhancing the fixing of ink by reacting to the recording liquid (ink).

On the other hand, a paper feed unit feeding the paper 12 stored in the paper storage unit 11 (thick plate) such as a paper feed cassette 10 includes a half-round runner (paper feed roller) 13 for separating and feeding a sheet of paper 12 from the paper storage-unit 11 and a separation pad 14 facing the paper feed roller 13A, the separation pad 14 being made of a material having a large coefficient of friction and biased to the half round roller 13.

A conveying unit conveying the record medium (paper) 12, fed from the paper feed unit, below the recording heads 7 includes a conveying belt 21 for attracting the paper 12 using electrostatic force and conveying the paper 12 and a counter roller 22 for holding the paper 12, fed from the paper feed unit via a guide 15, with the conveying belt 21 and conveying the paper 12. Further, the conveying unit includes a conveying guide 23 for causing the paper 12 fed in a substantially vertical direction to change a direction thereof about 90° and follow the conveying belt 21, and a tip pressing roller 25 biased to the conveying belt 21 by a pressing member 24. In addition, an electrifying roller 26 is disposed so as to construct an electrifying unit electrifying a surface of the conveying belt 21.

In this case, the conveying belt 21 includes an endless belt (a belt formed to have an endless shape in molding or a belt made to have an endless shape by connecting both ends thereof) and the conveying belt 21 is entrained between a conveying roller 27 and a tension roller 28. The conveying belt 21 is configured to go round in a belt conveying direction (sub-scanning direction) of FIG. 2 when the conveying roller 27 is rotated by a sub-scanning motor 31 via a timing belt 32 and a timing roller 33 In addition, a guide member 29 is disposed on the reverse of the conveying belt 21 for an image forming area by the recording heads 7.

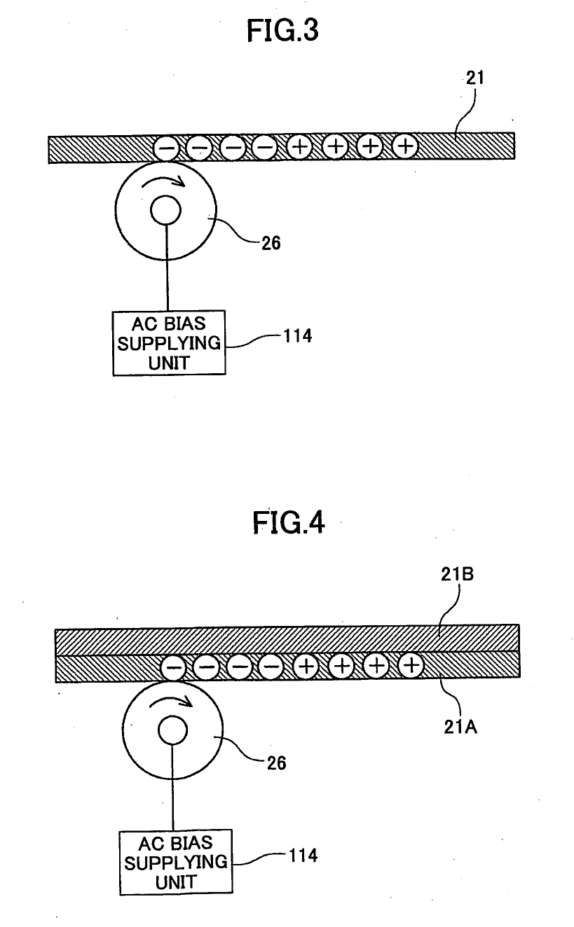

The conveying belt 21 may be a belt of a single-layered structure as shown in FIG. 3 or a belt of a multiple-layered (two or more) structure as shown in FIG. 4. If the conveying belt 21 has a single-layered structure, the conveying belt 21 is brought into contact with the paper 12 and the tension roller 28, so that an entire layer is formed with an insulating material. Also, if the conveying belt 21 has a multiple-layered structure, a side brought into contact with the paper 12 and the electrifying roller 26 is preferably formed with an insulating layer 21A and a side which is not brought into contact with the paper 12 or the electrifying roller 26 is preferably formed with a conductive layer 21B.

Preferably, examples of insulating materials for forming the conveying belt 21 of a single-layered structure and the insulating layer 21A of the conveying belt 21 of a multiple-layered structure include resin such as PET, PEI, PVDF, PC, ETFE, PTFE, and the like or elastomer which does not include conductivity controlling materials. The conveying belt 21 and the insulating layer 21A are formed such that volume resistivity thereof is not less than 10¹² Ωcm, preferably, 10¹⁵ Ωcm. Preferably, examples of materials for forming the conductive layer 21B of the conveying belt 21 of a multiple-layered structure include the above-mentioned resin or elastomer in which carbon is contained and the conductive layer 21B is formed such that volume resistivity thereof ranges from 10⁵ Ωcm to 10⁷ Ωcm.

The electrifying roller 26 is disposed such that the electrifying roller 26 is brought into contact with the insulating layer 21A constituting a surface layer of the conveying belt 21 (in the case of a multiple-layered structure) and is rotated in accordance with a rotation of the conveying belt 21. The electrifying roller 26 applies pressure to both ends of an axis thereof. The electrifying roller 26 is formed using a conductive member with volume resistivity ranging from 10⁶ to 10⁹ Ωcm. As will be described in the following, an AC bias of 2 kV, for example, in positive and negative polarity is applied to the electrifying roller 26 from an AC bias supplying unit 114. Although a waveform of the AC bias may be a sine wave or a triangular wave, a square wave is preferable.

As shown in FIG. 2, a slit disk 34 is attached to an axis of the conveying roller 27 and a sensor 35 is disposed so as to detect a slit of the slit disk 34. The slit disk 34 and the sensor 35 constitute an encoder 36.

As shown in FIG. 1, an encoder scale 42 with a formed slit is disposed in front of the carriage 3 and an encoder sensor 43 is disposed in front of the carriage 3, the encoder sensor 43 being made of a transmission-type photosensor detecting a slit of the encoder scale 42. These elements constitute an encoder 44 for detecting a position of the carriage 3 in the main scanning direction.

A paper ejecting unit ejecting the paper 12 recorded by the recording heads 7 includes a separation claw 51 for separating the paper 12 from the conveying belt 21, a paper ejecting roller 52, a paper ejecting runner 53, and a paper ejecting tray 54 for storing the paper 12 to be ejected.

A double-side paper feeding unit 61 is detachably mounted on a back of the image forming apparatus. The double-side paper feeding unit 61 takes in the paper 12 returned from a rotation of the conveying belt 21 in the reverse direction and turns over and feeds the paper 12 again between the counter roller 22 and the conveying belt 21.

In addition, the image forming apparatus may have an extension tray 70 mounted on a bottom thereof. The extension tray 70 includes a thick plate (paper placement plate) 71 for placing the paper 12 in the same manner as in the paper feed tray 10, a paper feed runner 73, and a separation pad 74. When paper is fed, a sheet of paper is separated and fed at one time using the paper feed runner 73 and the separation pad 74 and the paper is sent between the counter roller 22 and the conveying belt 21 from the lower portion of an apparatus body.

In addition, a surface resistance meter 80 for measuring surface resistivity of the fed paper 12 is disposed on a side portion (relative to the main scanning direction) of the paper feed runner 13 in a paper feed path for the paper 12.

In the image forming apparatus constructed in this manner, a sheet of the paper 12 is separated and fed at one time from the paper feed unit, the paper 12 fed in a substantially vertical direction is guided by the guide 15, held between the conveying belt 21 and the counter roller 22, and then conveyed. A tip end of the paper 12 is further guided by the conveying guide 23, pressed on the conveying belt 21 by the tip pressing roller 25, so that a conveying direction thereof is changed about 90°.

In this case, alternating voltage is applied to the electrifying roller 26 such that positive (plus) output and negative (minus) output are alternately repeated. Positive and negative charge is alternately applied to strips with a predetermined width on the conveying belt 21 in the sub-scanning direction, which is a rotation direction. When the paper 12 is fed on the conveying belt 21 positively and negatively electrified in an alternating manner, the paper 12 is attracted to the conveying belt 21 by attraction, the paper 12 is conveyed in the sub-scanning direction in accordance with a rotation movement of the conveying belt 21.

In view of this, ink drops are ejected on the paper 12 in a stationary status and one line is recorded by moving the carriage 3 and driving the recording heads 7 in accordance with an image signal. Recording of the next line is performed after the paper 12 is conveyed for a predetermined distance. When a recording end signal is received or a signal indicating that a rear end has reached a recording area is received, the recording operation is ended and the paper 12 ejected to the paper ejecting tray 54.

In a case of double-side printing, by reversing the rotation of the conveying belt 21 when recording on a front surface (a surface to be printed first) is ended, the recorded paper 12 is sent to the inside of the double-side paper feeding unit 61. The paper 12 is turned over (so that a rear surface becomes a printing surface) and fed between the counter roller 22 and the conveying belt 21 again. Then timing control is performed, the paper 12 is conveyed on the conveying belt 21 in the same manner as mentioned above, recording is performed on the rear surface, and then the paper 12 is ejected to the paper ejecting tray 54.

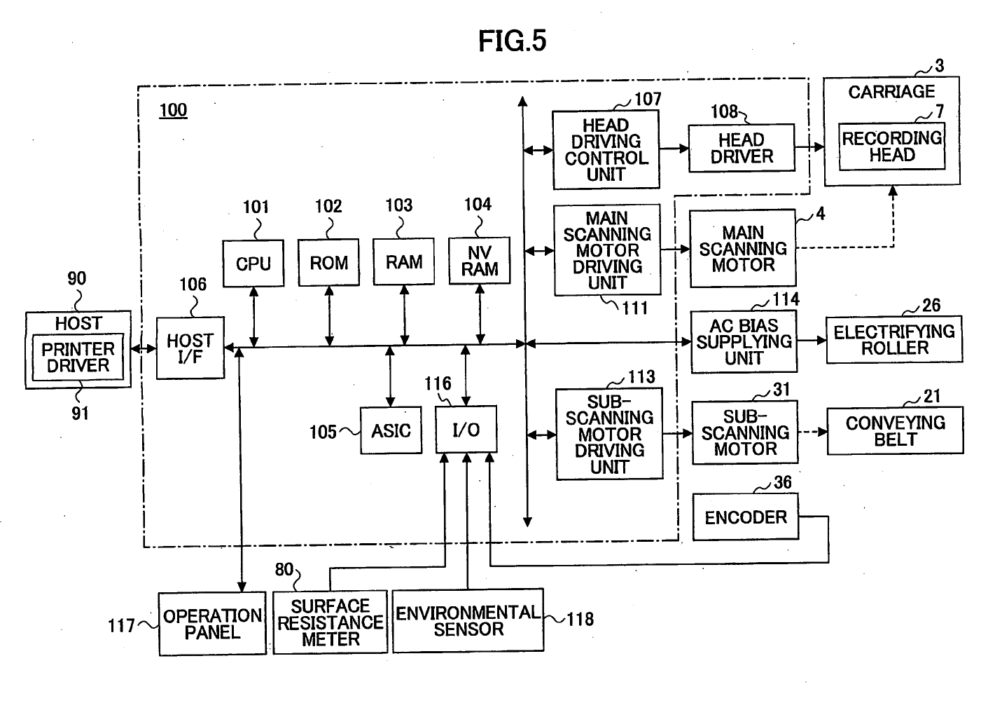

Next, an outline of a control unit of the image forming apparatus will be described with reference to a block diagram of FIG. 5.

A control unit 100 includes a CPU 101 for controlling the whole apparatus, a ROM 102 for storing a program executed by the CPU 101 and other fixed data, a RAM 103 for temporarily storing image data and the like, a non-volatile memory 104 capable of rewriting for holding data even when power supply to the apparatus is cut off, and an ASIC 105 for performing various types of signal processing on image data, image processing for rearranging images, and input/output signal processing for controlling the whole apparatus.

Further, the control unit 100 includes an I/F 106 for transmitting and receiving data and signals with a host 90, which is a data processing apparatus such as a personal computer, a head driving control unit 107 performing drive control on the recording heads 7 and a head driver 108, a main scanning motor driving unit 111 driving the main scanning motor 4, a sub-scanning motor driving unit 113 driving the sub-scanning motor 31, an encoder 34, an environmental sensor 118 for detecting environmental temperature and environmental humidity, the surface resistance meter 80 for detecting surface resistivity values of a record medium, the above-mentioned encoder 44 which is not shown in the drawing, and an I/O 116 for inputting detection signals from various types of other sensors and the like.

Moreover, an operation panel 117 for inputting and displaying information necessary for the apparatus is connected to the control unit 100. The control unit 100 controls switch-on/off operations of output of the AC bias supplying unit (high voltage power source) 114 applying an AC bias to the electrifying roller 26, for example.

In this case, the control unit 100 receives printing data and the like including image data using the I/F 106 via a cable or a network from the host 90 including a data processing apparatus such as a personal computer, an image reading apparatus such as an image scanner, an imaging apparatus such as a digital camera and the like. The generation and output of printing data to the control unit 100 is performed by a printer driver 91 on the host 90.

The CPU 101 reads out and analyzes the printing data in a receive buffer included in the I/F 106, performs data rearranging processing, for example, in the ASIC 105, and transmits image data to the head driving control unit 107. Conversion of the printing data to bitmap data so as to output an image is performed by converting the image data to bitmap data in the printer driver 91 on the host 90 and transmitting the bitmap data to the apparatus as mentioned above. However, the conversion may be performed using font data stored in the ROM 102, for example.

When the head driving control unit 107 receives image data (dot pattern data) corresponding to one line of the recording heads 7, the head driving control unit 107 transmits the dot pattern data for one line to the head driver 108 in serial data in synchronization with clock signals and also transmits a latch signal to the head driver 108 at a predetermined time.

The head driving control unit 107 includes a ROM (which may be constituted using the ROM 102) in which pattern data on driving waveforms (driving signals) is stored, a waveform generating circuit including a D/A converter for digital-to-analog converting the data on the driving waveform read out from the ROM, and a driving waveform generating circuit made of an amplifier and the like.

The head driver 108 includes a shift register for inputting clock signals and serial data as image data from the head driving control unit 107, a latch circuit for latching registration values of the shift register using latch signals from the head driving control unit 107, a level conversion circuit (level shifter) for changing levels of output values of the latch circuit, an analog switch array (switching unit) whose switch-on/off is controlled by the level shifter, and the like. By controlling the switch-on/off of the analog switch array, a required driving waveform included in driving waveforms is selectively applied to the actuator unit of the recording heads 7 so as to drive the heads.

The main scanning motor driving unit 111 calculates a control value based on a target value provided by the CPU 101 and a speed detection value obtained by sampling a detection pulse from the encoder 44. The main scanning motor driving unit 111 drives the main scanning motor 4 via an internal motor driver.

In the same manner, the sub-scanning motor driving unit 113 calculates a control value based on a target value provided by the CPU 101 and a speed detection value obtained by sampling a detection pulse from the encoder 36. The sub-scanning motor driving unit 113 drives the sub-scanning motor 31 via an internal motor driver.

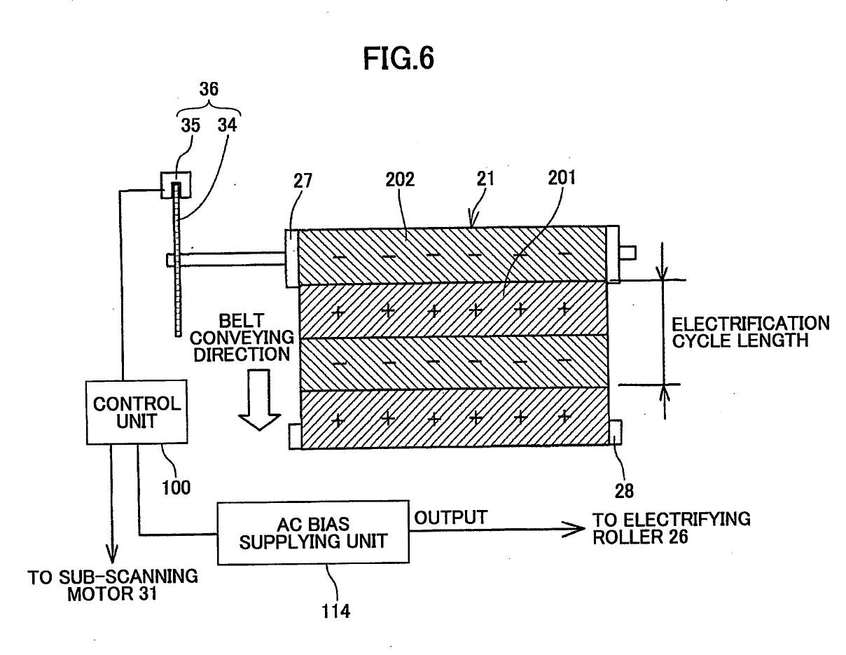

Electrification control on the conveying belt 21 of the image forming apparatus will be described with reference to FIG. 6 or later.

First, a portion relating to the electrification control on the conveying belt 21 is described with reference to FIG. 6. As mentioned above, rotation amount is detected using the encoder 36 disposed on an end portion of the conveying roller 27 for driving the conveying belt 21. The sub-scanning motor 31 is driven and controlled by the sub-scanning motor driving unit 113 of the control unit 100 in accordance with the detected rotation amount. At the same time, output of the AC bias supplying unit (high voltage power source) 114 applying high voltage (AC bias) to the electrifying roller 26 is controlled.

The AC bias supplying unit 114 controls a cycle of positive and negative voltage (application time) applied to the electrifying roller 26. At the same time, the control unit 100 controls driving of the conveying belt 21. Thus, it is possible to apply positive and negative electric charge on the conveying belt 21 in a predetermined electrification cycle length. In this case, the “electrification cycle length” is a width (distance) in the conveying direction in one cycle of positive and negative voltage application as shown in FIG. 6.

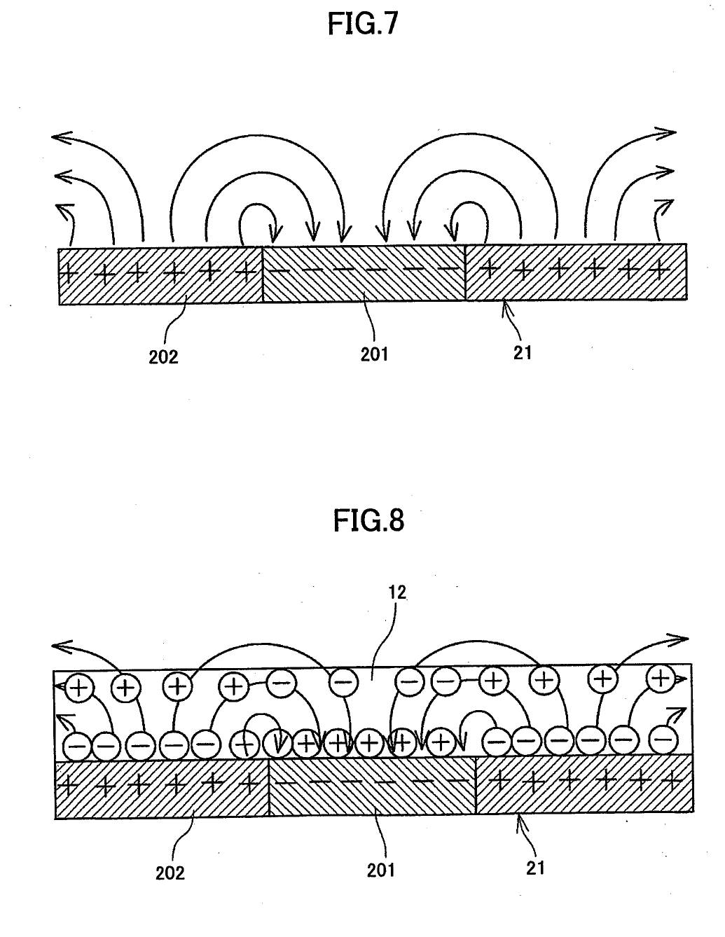

As mentioned above, when printing is started, the conveying belt 21 is rotated in the clockwise direction in FIG. 1 by driving and rotating the conveying roller 27 using the sub-scanning motor 31. At the same time, positive and negative square wave is applied to the electrifying roller 26 from the AC bias supplying unit 114. Accordingly, the electrifying roller 26 is in contact with the insulating layer 21A of the conveying belt 21, so that positive charge and negative charge are alternately applied to the insulating layer 21A of the conveying belt 21 as shown in FIG. 6 in the conveying direction of the conveying belt 21 (strips of positive electrification areas 201 and negative electrification areas 202 are alternately formed). As a result, a non-uniform electric field is generated on the conveying belt 21 as shown in FIG. 7.

The insulating layer 21A of the conveying belt 21 to which the positive and negative charge is applied is formed such that volume resistivity thereof is not less than 10¹² Ωcm, preferably, 10¹⁵ Ωcm. Thus, it is possible to prevent the positive and negative charge electrified in the insulating layer 21A to move across a boundary thereof and to hold the positive and negative charge applied to the insulating layer 21A.

On the other hand, surface resistivity of the paper 12 before or during paper feeding is measured by applying electric charge of 1 KV, for example, between two terminals of the surface resistance meter 80 capable of being in contact with the paper 12 disposed on the side of the paper feed runner 13 and measuring electric current flowing between the terminals.

The paper 12 whose surface resistivity is measured is separated by the paper feed runner 13 and the separation pad 14, and then sent to the conveying belt 21 where the non-uniform electric field is generated by forming the positive and negative charge on the insulating layer 21A. The paper 12 sent to the non-uniform electric field on the conveying belt 21 is instantaneously polarized along a direction of the electric field. As shown in FIG. 8, electric charge having attraction to the conveying belt on a conveying belt surface of the paper becomes dense due to the non-uniform electric field and electric charge having repulsion against the conveying belt 21 appearing on the opposite surface of the paper becomes sparse. The paper 12 is instantaneously attracted to the conveying belt 21 due to the difference of electric charge. At the same time, the paper 12 has limited resistance, so that true charge is induced on the attraction surface of the paper 12 and the opposite side thereof.

Positive and negative true charge induced on the attraction surface of the paper 12 has stable attraction by attracting with the electric charge applied on the conveying belt 21. However, positive and negative true charge induced on the opposite side is unstable.

The true charge induced on the attraction surface of the paper 12 and the surface of the opposite side are capable of moving since the paper 12 has a limited value of resistance, namely, a surface resistivity of 10⁷ Ω/sq to 10¹³ Ω/sq. Adjoining positive charge and negative charge are attracted to each other and moved, so that the positive charge and negative charge are reduced by neutralization.

As a result, the electric charge on the conveying belt 21 is balanced with the true charge induced on the attraction surface of the paper 12 and the electric field thereof is closed. The true charge induced on the opposite side of the attraction surface of the paper 12 is neutralized as mentioned above and the electric field thereof is closed. In other words, the electric field towards the recording heads 7 is reduced. Also, the electric charge applied on the conveying belt 21 and the electric charge having repulsion against the electric charge on the conveying belt 21 are reduced from the surface of the paper 12, so that attraction of the paper 12 to the conveying belt 21 is increased with the passage of time.

In this case, time for surface potential on the surface to be reduced and time for the electric charge to be eliminated are different depending on the value of resistance of the paper 12 and the electrification cycle length. In proportion as the resistance of the paper 12 increases, the amount of movement of the electric charge induced on the surface of the paper (opposite surface of the conveying belt) is reduced per unit time, so that the neutralization of the surface electric charge requires time. Further, in proportion as the electrification cycle length is increased, distance between the induced positive and negative charge is increased, so that substantial resistance when the electric charge is moved is increased. Further, electric potential affecting between the positive and negative charge is reduced in reverse proportion to the distance thereof, so that the neutralization of the surface electric charge requires time in the same manner.

Thus, if the value of resistance of the paper 12 is the same and the amount of electric charge applied to the conveying belt 21 per unit area is the same, disappearance time of electric charge on the surface of the paper (opposite surface of the conveying belt) is proportional to the square of the electrification cycle length.

The paper 12 attracted to the conveying belt 21 is conveyed below the recording heads 7 as mentioned above, the carriage 3 is reciprocated in the main scanning direction, and ink drops are ejected from the recording heads 7 at the same time, thereby forming an image on the paper 12 for a single reciprocation of the recording heads 7. When the image for a single reciprocation is formed, the paper 12 is sent to the next printing position by the conveying belt 21, and an image forming for a single reciprocation is performed again. When the image forming is ended, the paper is conveyed by the conveying belt 21, separated from the conveying belt 21 by the separation claw 51, and ejected on the paper ejecting tray 54.

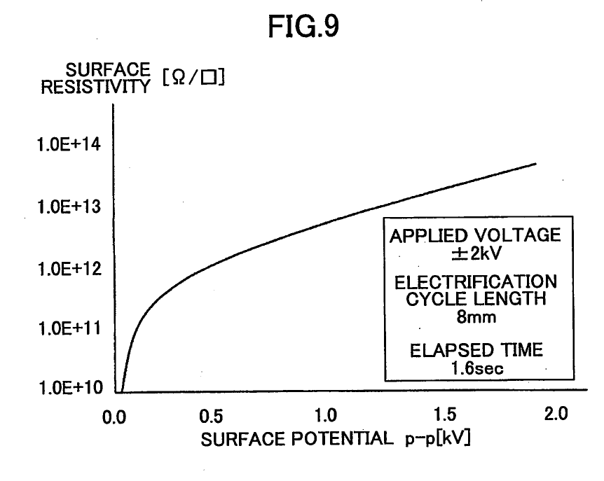

FIG. 9 shows an example of a correlation between surface potential and surface resistivity of the paper obtained from an experiment. In this experiment, the surface potential is measured on the assumption that the electrification cycle length is 8 mm, applied voltage is ±2.0 kV, elapsed time is 1.6 seconds after the conveying belt 21 is brought into contact with the paper 12. From the result of this experiment, as mentioned above, it is confirmed that the surface potential of the paper is increased in proportion as the surface resistivity of the paper is increased.

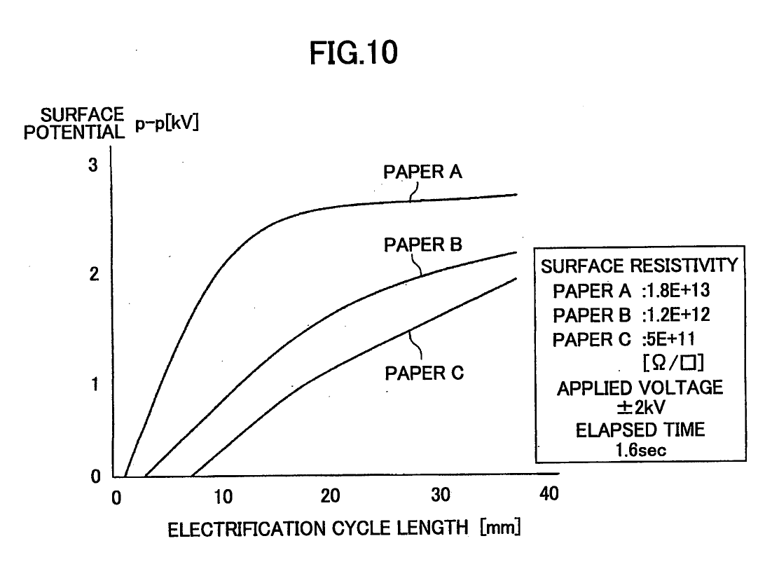

FIG. 10 shows an example of a relationship between the electrification cycle length and the surface potential of three types of paper (paper A: 1.8×10¹³ Ω/sq, paper B: 1.2×10¹²Ω/sq, and paper C: 5×10¹¹ Ω/sq) from an experiment, the three types of paper having different surface resistivity. In this experiment, the surface potential is measured on the assumption that applied voltage is ±2.0 kV, elapsed time is 1.6 seconds after the conveying belt 21 is brought into contact with the paper 12.

From the result of this experiment, it is confirmed that electrification cycle length where surface potential is eliminated (disappeared) is different in paper A, B, and C after the predetermined time (1.6 seconds), the paper A, B, and C having different resistance and that surface potential of the paper can be lowered by reducing (shortening) the electrification cycle length even when the surface resistivity of the paper is high. In other words, it is possible to adjust the amount of electric charge on the surface of the record medium conveyed to the recording position (image forming position) of the recording head by controlling the electrification cycle length.

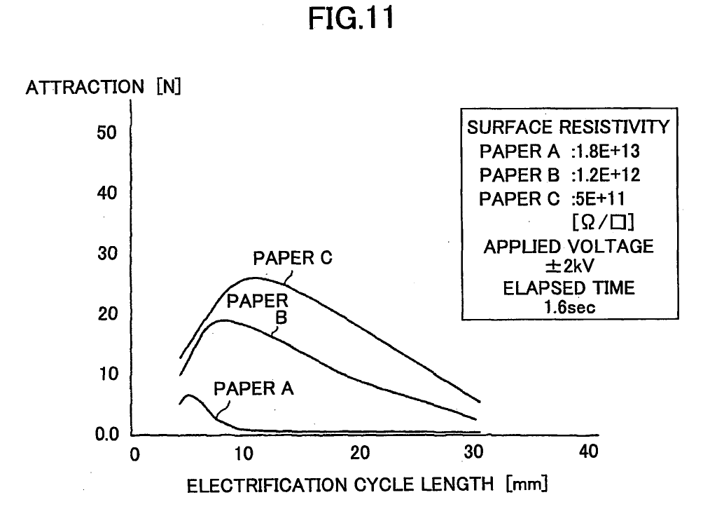

FIG. 11 shows a relationship between the attraction of the aforementioned three types of paper (A, B, and C) having different surface resistivity and the electrification cycle length. This experiment is conducted on the assumption that applied voltage is ±2.0 kV, elapsed time is 1.6 seconds after the conveying belt is brought into contact with the paper.

From the result of this experiment, it is confirmed that electrification cycle length where attraction is maximized is different in paper A, B, and C after a predetermined time (1.6 seconds), the paper A, B, and C having different surface resistivity of paper and that the attraction can be maximized by reducing (shortening) the electrification cycle length when the surface resistivity of the paper is high.

In other words, when the surface potential of the paper is lowered, attraction after a predetermined time is increased, so that it is possible to prevent the displacement of impact positions of droplets generated through an influence of an electric field and to prevent dirt on the head resulting from the backflow of mist to the recording heads 7. Accordingly, it is possible to have both accuracy upon conveying paper (and conveyance) and image quality.

However, as shown in FIG. 11, when the electrification cycle length is too short, rising loss of the AC bias supplying unit 114 and contribution rate of loss of electricity removal generated upon applying electric charge to the conveying belt 21 are increased. In accordance with this, sufficient electric charge is not applied to the conveying belt 21 and attraction is reduced. In other words, the electrification cycle length may result in poor quality if it is too long or too short, so that it is preferable to control the electrification cycle length to have an optimum value in accordance with the resistance of paper.

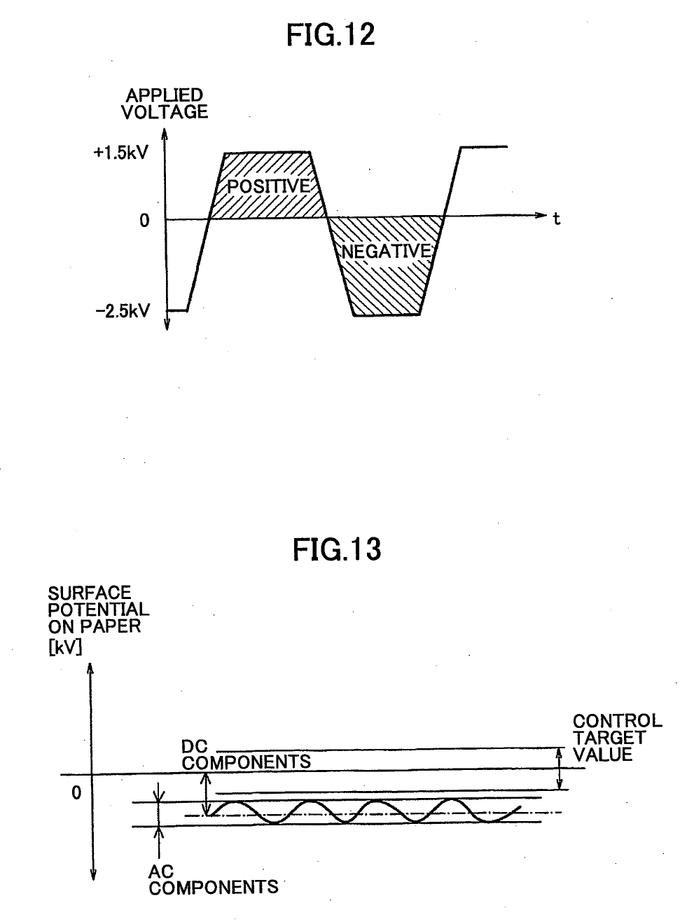

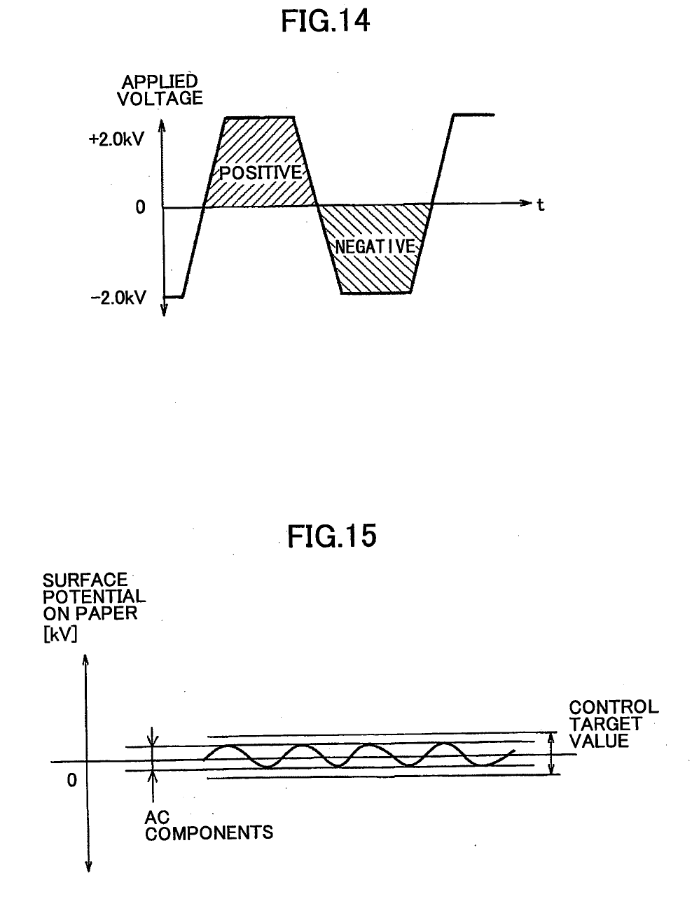

Next, balance between positive charge and negative charge applied to the conveying belt 21 and effect thereof is described with reference to FIGS. 12 to 15.

First, as shown in FIG. 12, when applying positive and negative charge to the conveying belt 21, if there is no balance between the positive charge and negative charge (in this example, positive charge is +1.5 kV and negative charge is −2.5 kV), it is not possible to have surface potential of the paper not more than a predetermined value (out of a range of a required control target value) as shown in FIG. 13 after a predetermined time has elapsed since the paper 12 is brought into contact with the conveying belt 21.

In other words, although the positive charge and negative charge induced on the paper 12 are neutralized with the passage of time, there is no balance between the positive charge and negative charge applied to the conveying belt 21. Thus, electric charge induced on the paper is out of balance and electric charge left on the paper after the neutralization is biased.

As a result, an absolute value of the surface potential on the paper becomes larger since DC components resulting from the bias of electric charge are added in addition to AC components determined in accordance with resistance of the paper, electrification cycle length, environment and the like. This may have a negative influence on phenomena such as the displacement of impact positions of ink drops generated through an influence of an electric field and the dirt on the head resulting from the backflow of mist to the recording heads.

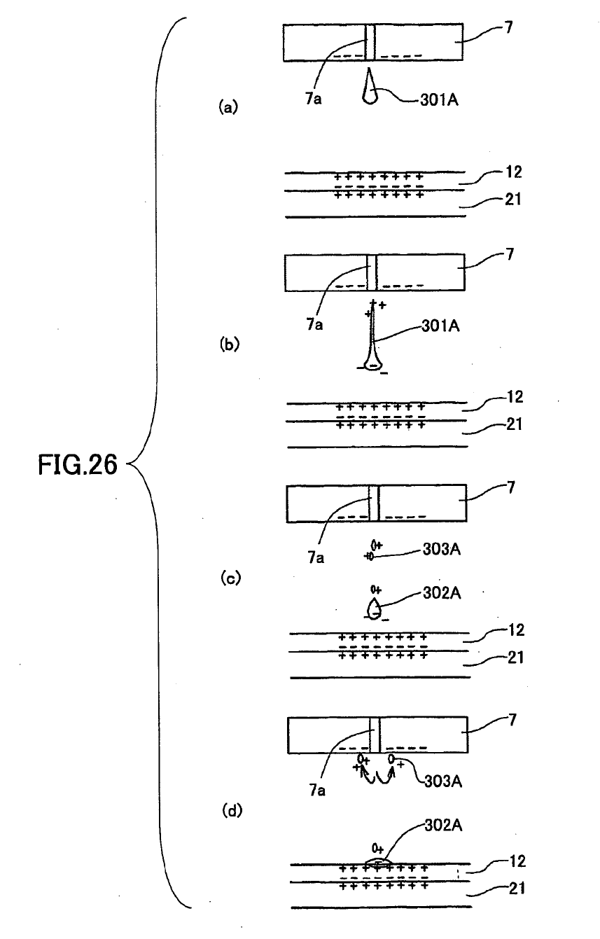

Next, the following describes the behavior of droplets when electric charge is on the paper 12 while the recording heads 7 ejects ink droplets on the paper 12 attracted on the conveying belt 21 with reference to FIG. 26.

As shown in FIG. 26-(a), ink droplets 301A ejected from a nozzle 7a of the recording heads 7 are affected by an electric field generated from surface potential on the paper 12 attracted to the conveying belt 21. As shown in FIG. 26-(b), true charge is induced in the ink droplets 301A and the ink droplets 301A are divided into main-drops 302A and mist (sub-drops) 303A. In this case, as shown in FIG. 26-(c), the mist 303A is likely to be electrified to have the same polarity as in the paper 12 in many cases, so that the mist 303A is repulsed by electric charge having the same polarity on the paper 12. As shown in FIG. 26-(d), the mist 303A flows back to the recording heads 7 and is attracted to the vicinity of an ink ejection surface of the recording heads 7.

Therefore, it is possible to prevent the backflow of the mist by reducing the electric charge (within the control target value) generating surface potential as mentioned above on the paper 12. However, if there is no balance between the positive charge and negative charge, DC components are placed.

Accordingly, surface potential exceeding the control target value is generated on the paper 12 and the backflow of mist, and the like is generated.

In view of this, by having substantially the same amount (areas of positive and negative fields) of electric charge for the positive and negative charge to be applied to the conveying belt 21, it is possible to control the surface potential on the paper to be not more than a predetermined value as shown in FIG. 15, namely, within the control target value after a predetermined time has elapsed since the paper 12 is brought into contact with the conveying belt 21. In accordance with this, it is possible to stably form a high-quality image without displacement of impact positions of ink drops or backflow of mist to the recording heads.

However, even if a value of positive output voltage and a value of negative output voltage are logically the same in a power pack (power source) constituting the AC bias supplying unit 114, the amount of positive charge and the amount of negative charge on the paper are not the same due to various reasons when electric charge is applied on the conveying belt 21 and the paper is conveyed.

In accordance with this, as will be described in the following, the amount of positive charge and negative charge when electric charge is applied on the conveying belt 21 is made to be substantially the same by applying different positive and negative waveforms to the conveying belt 21 from the AC bias supplying unit 114 via the electrifying roller 26, such that rise time and fall time are different, positive input time and negative time are different, or positive voltage value and negative voltage value are different.

In other words, voltage waveforms are applied such that the amount of positive charge and the amount of negative charge are substantially the same so as to have an absolute value of electric charge on the surface of the paper not more than a predetermined value after a predetermined time has elapsed since the paper is brought into contact with the conveying belt.

In this manner, by having a balance between the positive charge and negative charge on the surface of the paper, it is possible to form a high-quality image while having no displacement of impact positions of ink drops or backflow of mist to the recording heads.

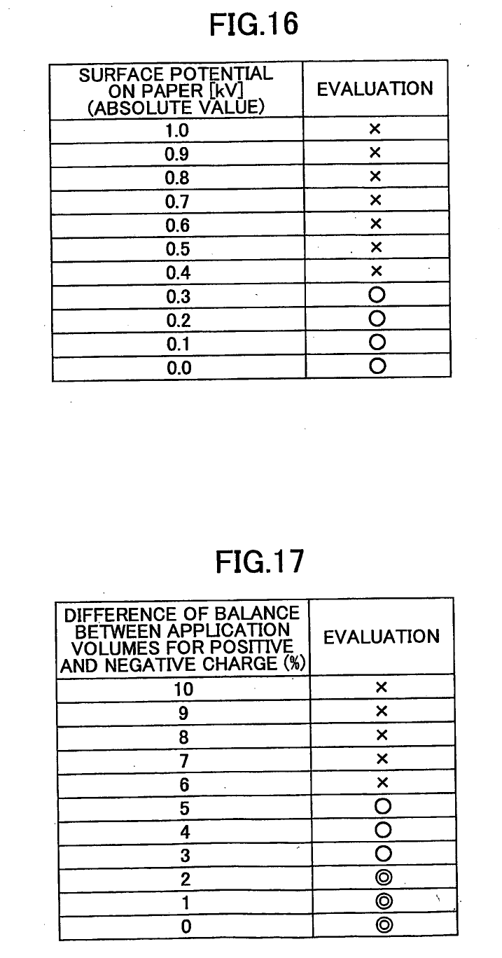

Regarding the predetermined value, a relationship between the absolute value on the surface of the paper and image quality is evaluated after the predetermined time has elapsed based on the dirt of mist on a nozzle surface of the recording heads when the surface potential on the paper is varied from 0 kV to 1.0 kV and the displacement of impact positions on the paper. FIG. 16 shows the result. The symbol “◯” in an evaluation column of FIG. 16 indicates no displacement of impact positions or mist dirt that has an influence on image quality, and the symbol “X” indicates degradation of image quality resulting from nozzle failure (non-ejection, for example) due to the displacement of impact positions or the mist dirt.

From this result, it is confirmed that by controlling the surface potential on the paper to be not more than 0.3 kV after the predetermined time has elapsed, it is possible to effectively form a high-quality image in a stable manner without the displacement of impact positions of ink drops or the backflow of mist to the recording heads 7.

Further, the mist dirt on the nozzle surface of the recording heads and the displacement of impact positions are evaluated while varying a difference of balance between application amount of positive charge and negative charge to the conveying belt 21 from 0% to 10%. FIG. 17 shows the result. The symbol “⊚” in an evaluation column of FIG. 17 indicates no displacement of impact positions or mist dirt, the symbol “◯” indicates no displacement of impact positions or mist dirt that has an influence on image quality, and the symbol “X” indicates degradation of image quality resulting from nozzle failure (non-ejection, for example) due to the displacement of impact positions or the mist dirt.

From this result, it is confirmed that by controlling the difference of balance between application amount of positive charge and negative charge to the conveying belt to be within 5%, preferably, within 2%, it is possible to more efficiently control an absolute value of the surface potential on the paper to be not more than the predetermined value after the predetermined time has elapsed, and that it is possible to more effectively form a high-quality image in a stable manner without the displacement of impact positions of ink drops or the backflow of mist to the recording heads 7.

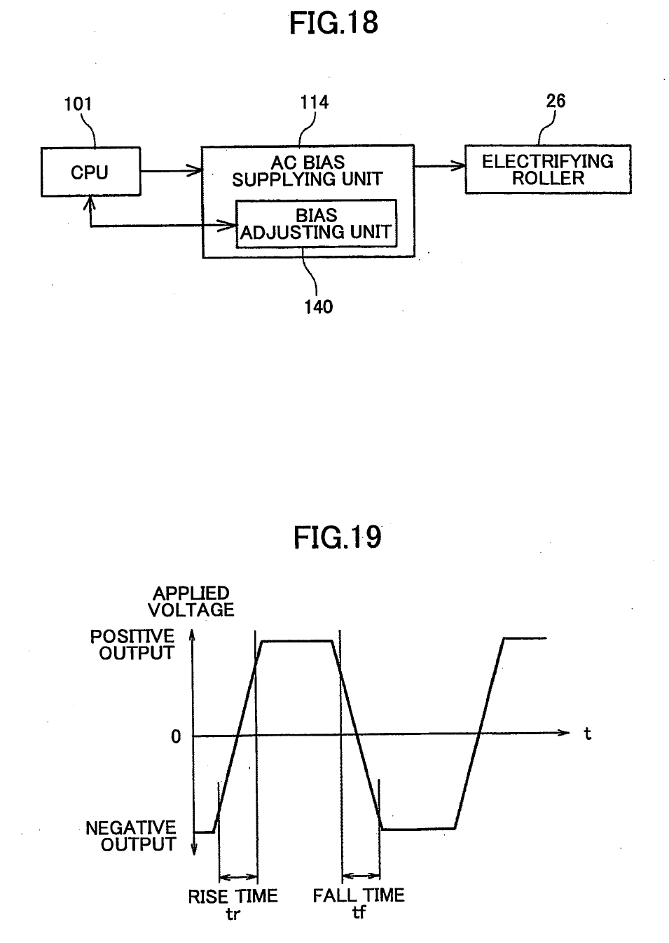

Next, other embodiment of the present invention is described with reference to FIG. 18. FIG. 18 is a block diagram showing main elements for applying electric charge in the embodiment.

In this embodiment, in the same manner as in the aforementioned embodiment, the CPU 101 is configured to control switch on/off of the AC bias supplying unit (high voltage power source) 114 applying an AC bias to the electrifying roller 26. In addition to this, the CPU 101 is configured to have a function of feedback control on each application value of positive and negative voltage.

Specifically, the CPU 101 includes a bias adjusting unit 140 adjusting positive and negative voltage values applied to the electrifying roller 26 by varying each resistance in circuits for positive and negative application in the AC bias supplying unit 114. The bias adjusting unit 140 includes an integrating circuit, and the CPU 101 adjusts the AC bias applied to the electrifying roller 26 such that by giving feedback of integration values of the positive and negative voltage values to the CPU 101, the integration values of the positive and negative voltage values are made to be substantially the same through the bias adjusting unit 140.

In accordance with this configuration, it is possible to have substantially the same amount of positive charge and negative charge applied to the conveying belt 21, to have the surface potential on the surface of the paper not more than the predetermined value (within the control target value) after the predetermined time has elapsed, and to stably form a high-quality image without the displacement of impact positions of ink drops or the backflow of mist to the recording heads.

Next, voltage waveforms applied to the conveying belt are described with reference to FIG. 19 or later. By having substantially the same amount of positive and negative charge applied to the conveying belt 21, it is possible to use at least either one of rise time tr and fall time tf of the positive and negative charge applied to the conveying belt 21.

First, as shown in FIG. 19, in theory, when a positive voltage value is equal to a negative voltage value, it is possible to have substantially the same amount of positive and negative charge by making the rise time tr to be the same as the fall time tf.

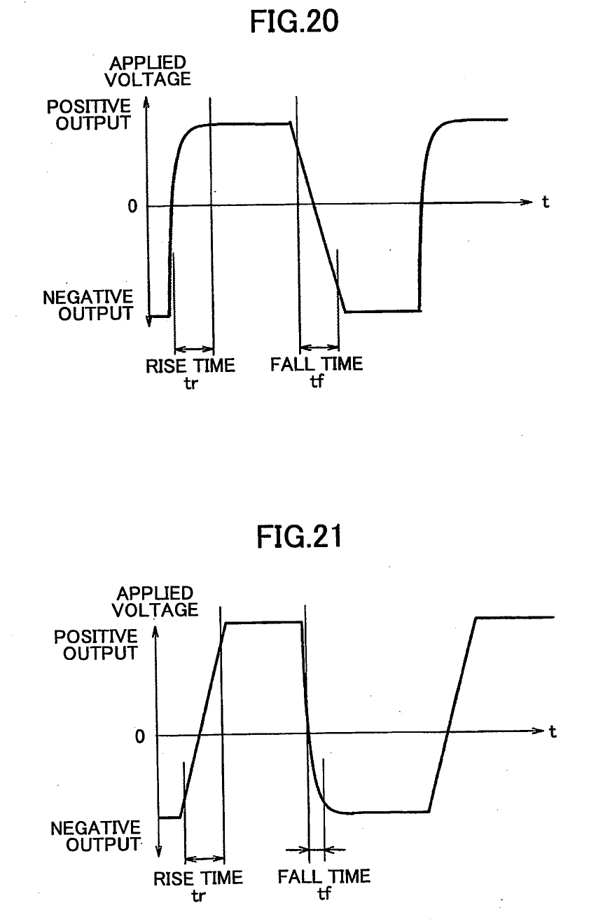

However, in some cases, it is difficult to have the same voltage value and the same application amount due to specifications of the circuit in the AC bias supplying unit 114, disparity of members, and the like. Accordingly, in practice, as shown in FIG. 20, when the positive voltage value is less than the negative voltage value, or the positive voltage value may be more than the negative value as shown in FIG. 21.

In this case, it is possible to have substantially the same amount of positive and negative charge applied to the conveying belt 21 by using transformers with different power for positive and negative charge constituting the AC bias supplying unit 114, or by performing a bias adjustment.

For example, when the positive voltage value is less than the negative voltage value as shown in FIG. 20, it is possible to have substantially the same amount of positive and negative charge (integration values of a positive area and a negative area in the drawing) by shortening the rise time tr for the positive charge relative to the fall time tf for the negative charge. By contrast, when the positive voltage value is more than the negative voltage value as shown in FIG. 21, it is possible to have substantially the same amount of positive and negative charge (integration values of a positive area and a negative area in the drawing) by increasing the rise time tf for the positive charge relative to the fall time tf for the negative charge.

As mentioned above, the application amount of electric charge is obtained as an integration value of applied electric charge. Accordingly, when the rise time is shortened by using a powerful transmitter for the positive charge, the application amount of the positive charge is increased. Also, when the fall time is shortened by using a powerful transmitter for the negative charge, the application amount of the negative charge is increased.

In this manner, even when it is difficult to have the same application amount of positive and negative charge, it is possible to have substantially the same amount of positive and negative charge applied to the conveying belt 21 by disposing transmitters dedicated to positive and negative charge.

Further, in order to have substantially the same amount of positive and negative charge applied to the conveying belt 21, it is possible to use positive input time and negative input time (rise and fall timing) for applying to the conveying belt 21.

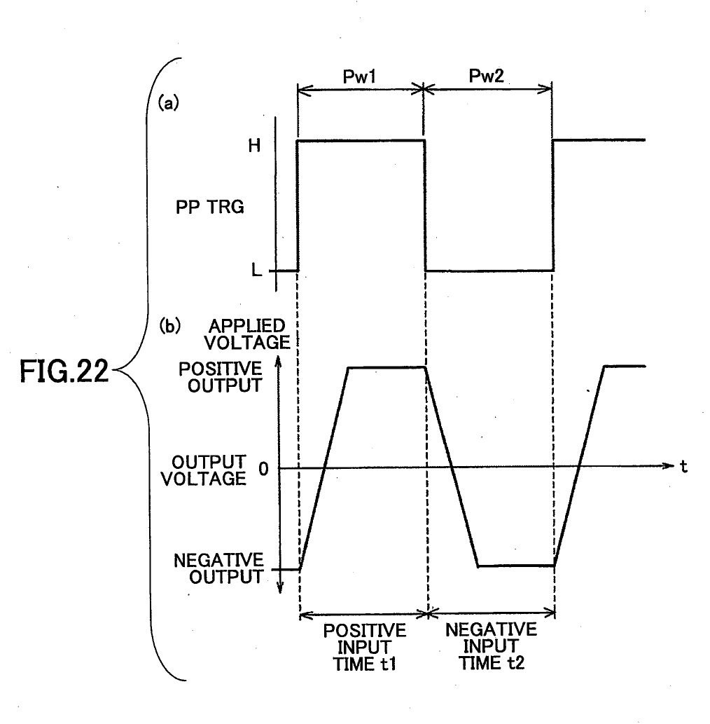

First, as shown in FIG. 22, in theory, when the positive voltage value is equal to the negative voltage value and the rise time tr is equal to the fall time tf, it is possible to have substantially the same application amount of positive and negative charge by making the same pulse width for a pulse width Pw1 for applying positive output and a pulse width Pw2 for applying negative output when switching voltage waveforms output from the AC bias supplying unit 114 through a driving signal PP TRG from the CPU 101 as shown in FIG. 22-(a) and thus having the same input time for positive input time t1 and negative input time t2 of output voltage as shown in FIG. 22-(b).

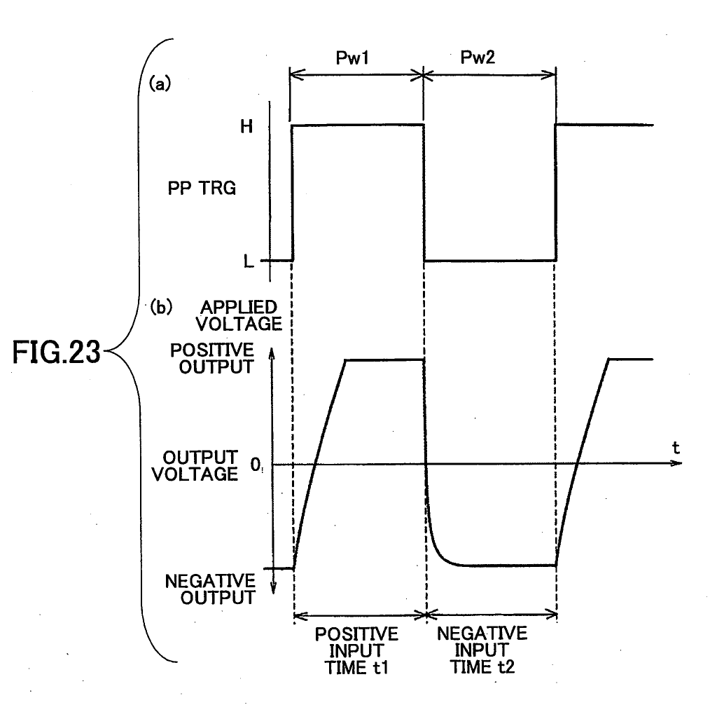

However, as mentioned above, even when a driving signal PP TRG of the pulse width Pw1=Pw2 (t1=t2) is applied to the AC bias supplying unit 114 as shown in FIG. 23-(a), difference may be generated in application amount of positive and negative charge (application amount of negative charge is increased in this example) as shown in FIG. 23-(b) due to specifications of the circuit in the AC bias supplying unit 114, disparity of members, and the like.

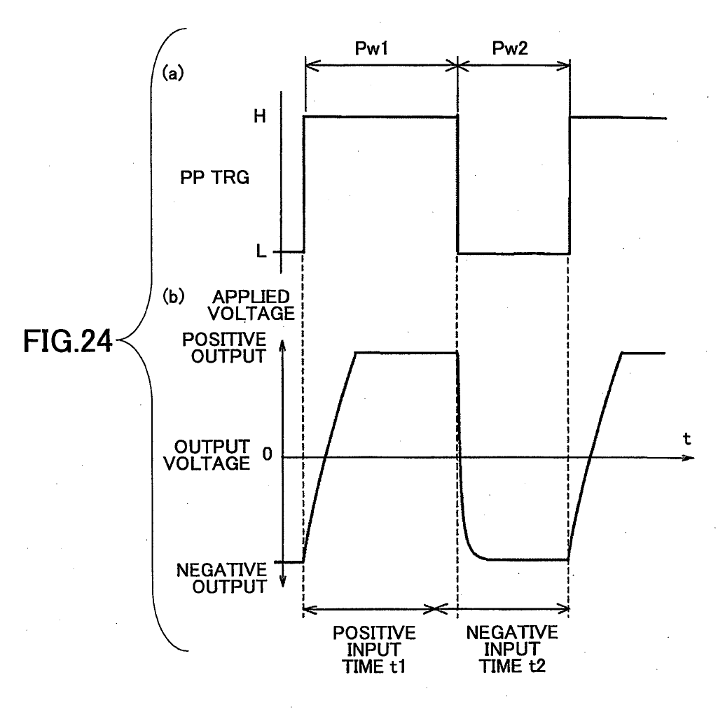

Thus, in the case as shown in FIG. 23, by increasing the pulse width Pw1 for causing the AC bias supplying unit 114 to output positive voltage relative to the pulse width Pw2 for causing output of negative voltage as shown FIG. 24-(a) among driving signals applied to the AC bias supplying unit 114, the positive input time t1 is increased relative to the negative input time t2 as shown in FIG. 23-(b), thereby having substantially the same application amount of positive and negative charge. When application amount of positive charge is increased in contrast to the case shown in FIG. 23, the pulse width Pw1 for causing output of positive charge may be reduced relative to the Pw2 for causing output of negative charge.

In this case, the AC bias output from the AC bias supplying unit 114 may be set in advance as mentioned above such that application amount of positive and negative charge is substantially the same or the AC bias may be adjusted by feedback controlling.

As mentioned above, this image forming apparatus employs the methods for having substantially the same amount of positive and negative charge applied to the conveying belt 21 as methods for controlling an absolute value of electric charge on the surface of the paper to be not more than a predetermined value after a predetermined time has elapsed.

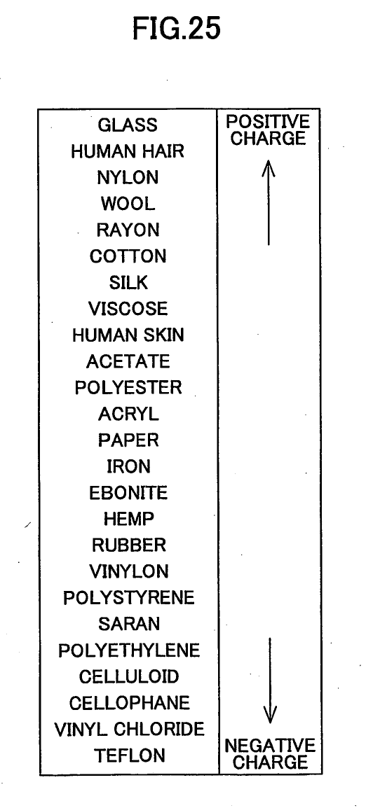

However, when the conveying belt 21 is rotated so as to convey the paper, the conveying belt 21 is charged through friction with the conveying roller 27, the tension roller 28, paper powder removing Mylar not shown in the drawings, the Mylar removing paper powder on the conveying belt 21, the record medium (paper), and the like. The polarity of a substance upon frictional electrification is determined based on a relationship with other substance for the friction (refer to triboelectric series in FIG. 25, where substances on a positive charge side are likely to be positively charged and substances on a negative charge side are likely to be negatively charged). In the image forming apparatus, the conveying belt 21 is negatively charged by friction when it is rotated.

In accordance with this, when the amount of positive and negative charge applied to the conveying belt 21 is completely the same, electric charge on the surface of the paper becomes slightly negative due to the frictional electrification resulting from the rotation of the conveying belt 21 after a predetermined time has elapsed.

In view of this, an experiment is conducted. As a result, it is confirmed that the effect of the frictional electrification can be offset by increasing application amount of positive charge by 2% relative to negative charge.

In other words, when applying positive and negative charge to the conveying belt 21, it is possible to readily control the surface potential of the paper to be not more than a predetermined value after a predetermined time has elapsed by applying electric charge having a polarity opposite to that of electric charge of frictional electrification, application amount of the electric charge having the opposite polarity being greater than that of the electric charge of the frictional electrification generated by a rotation of the conveying belt. Thus, it is possible to stably form a high-quality image without the displacement of impact positions of ink drops or the backflow of ink mist to the recording heads.

Further, the value of resistance of the paper is changed in accordance with humidity, so that when an AC bias is adjusted in other embodiment, even if the adjustment is made such that application amount of positive and negative charge is substantially the same using 50% RH as a standard, for example, the value of resistance of the paper is increased when environmental humidity is reduced below the standard, and the value of resistance of the paper is decreased when the environmental humidity is increased to the contrary. As a result, balance may not be secured between positive charge and negative charge in accordance with the change of the value of resistance. In this case, it is possible to more accurately control the surface potential of the paper within the control target value by adjusting application amount of positive and negative charge based on detection of humidity detected by the above-mentioned environmental sensor 118.

Further, as mentioned above, the reduction amount of the surface potential on the paper and time for the elimination of electric charge is also changed in accordance the width of positive and negative electric charge (electrification cycle length). Thus, it is possible to more accurately control the surface potential of the paper within the control target value by adjusting application amount of positive and negative charge based on the electrification cycle length.

Next, a relationship between the electrifying roller 26 and the environmental humidity is described. In the electrifying roller 26, a resistance value thereof is changed when the environmental humidity is high or low. Accordingly, when electric charge of 2 kVp-p is applied to the conveying belt 21, for example, even if an AC bias of a constant voltage value is applied from the AC bias supplying unit 114, the amount of electric charge applied to the conveying belt 21 is different depending on the environmental humidity.

In view of this, it is possible to apply required electric charge to the conveying belt 21 and to prevent degradation of the conveyance due to lack of attraction of the paper by varying a voltage value of output voltage applied to the electrifying roller 26 from the AC bias supplying unit 114 based on the environmental humidity detected by the environmental sensor 118.

For example, when electric charge of ±2 k is applied to the conveying belt 21, if detected humidity is high (not less than a first predetermined value), output voltage (AC bias) is controlled to be low (1.9 kVp-p, for example) and if the detected humidity is low (not more than a second predetermined value), the output voltage (AC bias) is controlled to be high (2.1 kVp-p, for example). In addition, the first predetermined value and the second predetermined value may be the same (voltage switching may have only two stages). Also, a method for controlling may be used in which application amount of electric charge applied in practice is estimated from the humidity without varying the output.

The present invention is not limited to the specifically disclosed embodiment, and variations and modifications may be made without departing from the scope of the present invention.

The present application is based on Japanese priority application No. 2005-207913 filed Jul. 19, 2005, the entire contents of which are hereby incorporated herein by reference.

1. An image forming apparatus comprising:
a conveying belt conveying a record medium attracted to the conveying belt using electrostatic force;
a recording head for ejecting droplets on the record medium and forming an image; and
a voltage waveform applying unit applying voltage waveforms, in which the shape of a positive waveform and the shape of a negative waveform are different, to the conveying belt so as to apply positive and negative electric charge thereto and generate the electrostatic force.

2. The image forming apparatus according to claim 1, wherein
the voltage waveform applying unit applies one of the waveforms such that the amount of the positive electric charge and the amount of the negative electric charge applied to the conveying belt are substantially the same so as to have an absolute value of electric charge on a surface of the record medium not more than a predetermined value after a predetermined time has elapsed since the record medium is brought into contact with the conveying belt.

3. The image forming apparatus according to claim 2, wherein
the absolute value of electric charge on the surface of the record medium is not more than 0.3 kV after the predetermined time has elapsed.

4. The image forming apparatus according to claim 2, wherein
a difference of the amount of an absolute value between the positive electric charge and the negative electric charge applied to the conveying belt is not more than 5%.

5. An image forming apparatus comprising:
a conveying belt conveying a record medium attracted to the conveying belt using electrostatic force generated by applying positive and negative electric charge thereto;
a recording head for ejecting droplets on the record medium and forming an image; and
an adjusting unit adjusting the amount of the positive electric charge and the amount of the negative electric charge applied to the conveying belt so as to have an absolute value of electric charge on a surface of the record medium not more than a predetermined value after a predetermined time has elapsed since the record medium is brought into contact with the conveying belt.

6. The image forming apparatus according to claim 5, wherein
the adjusting unit adjusts the amount of the positive electric charge and the amount of the negative electric charge applied to the conveying belt by adjusting an alternating voltage for positive and negative electric charge applied to the conveying belt.

7. The image forming apparatus according to claim 6, wherein
the adjusting unit adjusts the amount of the positive electric charge and the amount of the negative electric charge applied to the conveying belt by adjusting a length of a rise time or a length of a fall time of an alternating voltage for positive and negative electric charge applied to the conveying belt.

8. The image forming apparatus according to claim 6, wherein
the adjusting unit adjusts the amount of the positive electric charge and the amount of the negative electric charge applied to the conveying belt by adjusting time of rising or falling of an alternating voltage for positive and negative electric charge applied to the conveying belt.

9. The image forming apparatus according to claim 1, wherein
when the positive and negative electric charge is applied to the conveying belt, electric charge having a polarity opposite to that of electric charge of frictional electrification is applied, the amount of the electric charge having the opposite polarity applied to the conveying belt being greater than that of the electric charge of the frictional electrification generated by a rotation of the conveying belt.

10. The image forming apparatus according to claim 1, wherein
when the positive and negative electric charge is applied to the conveying belt, electric charge having a polarity opposite to that of electric charge of frictional electrification is applied, the amount of the electric charge having the opposite polarity applied to the conveying belt being greater than that of electric charge having the same polarity as in the frictional electrification generated by a rotation of the conveying belt.

11. The image forming apparatus according to claim 5, wherein
the adjusting unit adjusts the amount of the electric charge in accordance with widths of areas of positive and negative electric charge in a conveying direction of the conveying belt, the positive and negative electric charge being applied to the conveying belt.

12. The image forming apparatus according to claim 5, wherein
the adjusting unit adjusts the amount of the electric charge applied to the conveying belt in accordance with environmental humidity.
